(19) United States
(12) Patent Application Publication
(10) Pub. No.: US 2008/0091654 A1
(43) Pub. Date: Apr. 17, 2008

(54) Constellation Search Apparatus, Constellation Search Program, And Computer-Readable Storage Medium Storing Constellation Search Program

(76) Inventors: Dae Hee Kang, Incheon Metropolitan City (KR); Jae Sun Won, Seoul (KR); Jeong Su Hwang, Gyeonggi-do (KR)

Correspondence Address: DICKSTEIN SHAPIRO LLP, 1825 EYE STREET NW, Washington, DC, 20006-5403, US

(21) Appl. No.: 11/665,253

(22) PCT Filed: Sep. 30, 2005
(86) PCT No.: PCT/KR05/03240

§ 371 Date: Apr. 12, 2007

(30) Foreign Application Priority Data
Oct. 14, 2004 (KR) 10-2004-0082190

(51) Int. Cl. G06F 7/06

(52) U.S. Cl. 707/3; 707/E17.014

(57) ABSTRACT

The present invention is to provide a constellation search apparatus, method, and program, and a computer-readable storage medium storing the constellation search program, which can search for the constellations for a direction desired by a user, at any time, anywhere, and in any environment, and can quickly provide various pieces of information about the constellations that are found. The constellation search apparatus includes a database for storing information about locations of a plurality of constellations; a constellation search means comprising a reception unit for receiving azimuth and altitude values for a direction indicated by a 3-dimensional direction measurement means; a constellation search unit for searching for constellations located at the azimuth and altitude values, which are received by the reception unit, based on the constellation location information stored in the database; and an output unit for outputting search results found by the constellation search unit.

### TECHNICAL FIELD

The present invention relates, in general, to a constellation search apparatus, method and program, and a computer-readable storage medium storing the constellation search program and, more particularly, to an apparatus, a method, a program, and a storage medium, which allows a user, without special knowledge about the constellations, to easily acquire information about constellations.

### BACKGROUND ART

Generally, everybody, regardless of age or gender, can easily observe constellations.

### DISCLOSURE OF INVENTION

### Technical Problem

Due to insufficient knowledge about astronomical constellations, people in general do not sufficiently understand constellations even by viewing the constellations, so that they easily lose interest in observing constellations.

Conventionally, to overcome such a disadvantage, some apparatuses have been devised. The most general method is a scheme of projecting images, including stars and constellations, on a constellation observation hemisphere so that the projected images may be viewed by a user. Such a scheme provides detailed information about stars and constellations to the user without considering the user's wishes, so that the user's desire is not satisfied. Furthermore, actual stars and the images thereof cannot be simultaneously compared with each other. This hinders the user's understanding.

There is a transparent constellation observation hemisphere that can solve some of the disadvantages. However, it is difficult to use the transparent constellation observation hemisphere because the apparatus must be physically adjusted based on the information of the current time and season, and is disadvantageous in that it cannot be used in an overcast weather in which stars cannot be observed. Furthermore, such apparatuses are relatively large in size, so that they are disadvantageous in that an observation cannot be conducted at a place desired by a user where it is not possible to carry them to. Also, the amount of detailed information about stars and constellations that can be provided is small.

Accordingly, the present invention has been made keeping in mind of the above problems occurring in the prior art, and an object of the present invention is to provide a constellation search apparatus, which can search for constellations for a direction desired by a user, at any time, anywhere, and in any environment, and can quickly provide various pieces of information about the constellations found.

Another object of the present invention is to provide a constellation search method, which can search for the constellations for a direction desired by a user, at any time, anywhere, and in any environment, and can quickly provide various pieces of information about the constellations found.

A further object of the present invention is to provide a constellation search program and computer-readable recording medium storing the constellation search program, which can search for constellations for a direction desired by a user, at any time, anywhere, and in any environment, and can quickly provide various pieces of information about the constellations found.

### Technical Solution

In order to accomplish the above objects, a constellation search apparatus according to the present invention includes a database for storing information about locations of a plurality of constellations; and a constellation search means including a reception unit for receiving azimuth and altitude values for a direction indicated by a 3-dimensional direction measurement means, a constellation search unit for searching for constellations located at the azimuth and altitude values, which are received by the reception unit, based on the constellation location information stored in the database, and an output unit for outputting search results found by the constellation search unit.

Furthermore, a constellation search apparatus according to the present invention includes a database for storing information about locations of a plurality of constellations; a constellation search means including a reception unit for receiving azimuth and altitude values for a direction indicated by a 3-dimensional direction measure means, a constellation search unit for performing signal processing such that the azimuth and altitude values, which are received by the reception unit, are displayed on a screen, and calculating azimuth and altitude values for a selected constellation based on the constellation location information stored in the database in response to the input of IDentification (ID) information of a selected constellation, and an output unit for outputting current azimuth and altitude that are provided by the constellation search unit and indicated by the 3-dimensional direction measurement means and outputting the azimuth and altitude calculated for a selected constellation.

In addition, a constellation search method according to the present invention includes the first step of a constellation search means receiving azimuth and altitude values for a direction indicated by a 3-dimensional direction measurement means; the second step of the constellation search means searching for constellations located at the received azimuth and altitude values based on constellation location information stored in a database; and the third step of the constellation search means outputting search results.

Furthermore, a constellation search method according to the present invention includes the first step of a constellation search means receiving azimuth and altitude values for a direction indicated by a 3-dimensional direction measurement means; the second step of the constellation search means performing signal processing such that received azimuth and altitude values are displayed on a screen, and calculating azimuth and altitude values for a selected constellation based on the constellation location information in the database, in response to the input of ID information about the selected constellation; and the third step of the constellation search means outputting the signal-processed current azimuth and altitude indicated by the 3-dimensional direction measurement means and outputting the azimuth and altitude calculated on the selected constellation.

In addition, a computer-readable recording medium according to the present invention stores a constellation search program for implementing function of a storage means having previously stored information about locations of a plurality of constellations; and a constellation search means including a reception unit for receiving azimuth and altitude values for a direction indicated by a 3-dimensional direction measurement means, a constellation search unit for searching for constellations located at azimuth and altitude values received by the reception unit, based on the constellation location information stored in the storage means, and an output unit for outputting search results found by the constellation search unit.

Furthermore, a computer-readable recording medium according to the present invention stores a constellation search program for implementing function of a storage means having previously stored constellation location information about the locations of a plurality of constellations; and a reception unit for receiving azimuth and altitude values for a direction indicated by a 3-dimensional direction measurement means, a constellation search unit for performing signal processing such that the azimuth and altitude values, which are received by the reception unit, are displayed on a screen, and calculating azimuth and altitude values for a selected constellation, based on the constellation location information in the storage means, in response to input of ID information for the selected constellation, and an output unit for outputting current azimuth and altitude values that are provided by the constellation search unit and indicated by the 3-dimensional direction measurement means and outputting the azimuth and altitude values calculated for the selected constellation.

In addition, a constellation search program, according to the present invention, implements the functions of a storage means having previously stored information about the locations of a plurality of constellations; a constellation search means including a reception unit for receiving azimuth and altitude values for a direction indicated by a 3-dimensional direction measurement means; a constellation search unit for searching for constellations located at azimuth and altitude values received by the reception unit based on the constellation location information stored in the storage means; and an output unit for outputting search results found by the constellation search unit.

Furthermore, a constellation search program according to the present invention implements the functions of a storage means having previously stored constellation location information about locations of a plurality of constellations; a constellation search means including and a reception unit for receiving azimuth and altitude values for a direction indicated by a 3-dimensional direction measurement means, a constellation search unit for performing signal processing such that the azimuth and altitude values, which are received by the reception unit, are displayed on a screen, and calculating azimuth and altitude values of a selected constellation, based on the constellation location information of the storage means, in response to input of ID information for the selected constellation, and an output unit for outputting current azimuth and altitude that are provided by the constellation search unit and indicated by the 3-dimensional direction measurement means and outputting the azimuth and altitude values calculated for the selected constellation.

### Advantageous Effects

According to the present invention, when an apparatus for detecting motion in 3-dimensional space is connected to a fixed-type personal computer, and the apparatus is oriented toward the sky, information about constellations having corresponding direction information (for example, names, shapes, and related stories) is automatically searched for, displayed on a virtual sky, and outputted using a voice so that a user can easily understand and observe the constellations.

Furthermore, the apparatus for motion in 3-dimensional space can be connected to or mounted in a mobile terminal, such as a mobile phone, a notebook, a Personal Digital Assistant (PDA) or an MPEG-1 Audio Layer-3 (MP3) player. In this case, the apparatus is convenient to carry, and information about constellations in a desired direction and desired constellations can be obtained at any time, anywhere, and in any environment regardless of the location of the user.

Particularly, in the case where the apparatus is used in an area in which the stars in the night sky are not properly viewed, desired constellations can be displayed on a virtual sky so that there is an advantage in that the effectiveness of astronomical study is increased.

### BRIEF DESCRIPTION OF THE DRAWINGS

FIG. 1 is a block diagram of a constellation search apparatus according to the present invention;

FIG. 2 is a block diagram showing the internal construction of the 3-dimensional module of FIG. 1;

FIG. 3 is a block diagram showing the internal construction of the constellation search means of FIG. 1 according to a first embodiment of the present invention;

FIG. 4 is a block diagram showing the internal construction of the constellation search means of FIG. 1 according to a second embodiment of the present invention;

FIG. 5 is a flowchart illustrating a method of searching for and providing the constellation information in the direction indicated by the 3-dimensional module of FIG. 1;

FIG. 6 is an example of a screen adopted for the description of FIG. 5;

FIG. 7 is a flowchart illustrating a method of searching for a desired constellation input by a user;

FIG. 8 is an example of a screen adopted for the description of FIG. 7;

FIG. 9 is a view of the apparatus of the present invention implemented in a mobile phone;

FIG. 10 is a block diagram of apparatus of the present invention implemented in a mobile phone;

FIGS. 11 and 12 are views of the apparatus of the present invention implemented in the 3-dimensional module of FIG. 1;

FIGS. 13 and 14 are modified examples of FIGS. 11 and 12; and

FIG. 15 is a diagram showing the apparatus of the present invention implemented in a MP3 player.

### DESCRIPTION OF REFERENCE NUMERALS OF PRINCIPAL ELEMENTS

10: 3-dimensional module 12: terrestrial magnetism sensor

14: tilt sensor 16: coordinate conversion unit

18: azimuth angle calculation unit

20: database

30: output means 40: constellation search means

100, 110: reception unit

102, 114: constellation search unit

104, 112: output unit

106: virtual sky implementation unit

### MODE FOR THE INVENTION

A constellation search apparatus and method according to the present invention are described in detail with reference to the accompanying drawings below.

FIG. 1 is a block diagram of a constellation search apparatus according to the present invention. The constellation search apparatus includes a 3-dimensional module 10 for measuring directions in 3-dimensions and outputting an azimuth and an altitude; a database 20 having a plurality of pieces of constellation information (for example, constellation names, constellation locations (declinations, right ascensions), features, and related stories) previously stored in a look-up table form; an output means 30 including a screen display unit, such as a video monitor, a small-sized liquid crystal display panel, and/or a voice output unit, such as a speaker; and a constellation search means 40 for storing a program, which enables constellation searching, therein, reading all the constellation information in the database 20, and displaying the read information on a virtual sky (that is, a computed sky that exists in a program), and locating the virtual sky at the azimuth and altitude input through the 3-dimensional module 10, determining whether a constellation exists in the virtual sky, and outputting the search results through the output means 30.

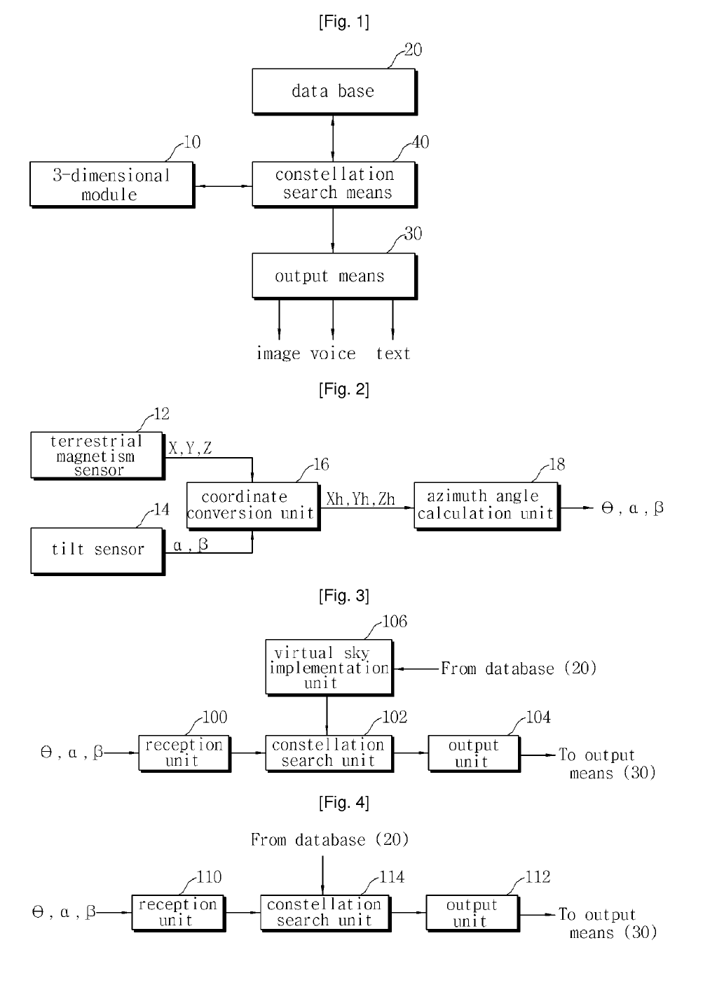

The 3-dimensional module 10, as shown in FIG. 2, includes a terrestrial magnetism sensor 12 for detecting the flow of a magnetic field generated by the earth and outputting magnetism vectors X, Y, and Z; a tilt sensor 14 for detecting the tilt, pitch, and roll of a corresponding 3-dimensional module and outputting a pitch angle α and a roll angle β; a coordinate conversion unit 16 for receiving the magnetism vectors X, Y, and Z from the terrestrial magnetism sensor 12, and the pitch angle α and the roll angle β from the tilt sensor 14, performing coordinate conversion, and calculating horizontal magnetism vectors Xh, Yh, and Zh; and an azimuth angle calculation unit 18 for calculating an azimuth angle θ based on the X-axis component Xh and Y-axis component Yh of the horizontal magnetism vectors Xh, Yh and Zh provided from the coordinate conversion unit 16, and transferring the calculated azimuth angle θ, the pitch angle (α; altitude), and the roll angle (β; tilt) to constellation search means 40.

Information stored in the database 20 may be updated. Among the plurality of pieces of constellation information stored in the database 20, location information is values (a declination and a right ascension) set on the basis of an equatorial coordinate system. The equatorial coordinate system is a spherical coordinate system used for indicating the location of a celestial body in a celestial sphere. In the equatorial coordinate system, a longitude, measured in such a manner that the spring equinox is selected as an origin of the longitude from among points at which the ecliptic, which is tilted by 23.5 degrees from the equator of the sky obtained by extending the equator of the earth into the celestial sphere and which is the path along which the sun moves, meets the equator, and the longitude is measured for the eastern direction, is called the right ascension. A latitude, indicated in such a manner that the equator is set to 0, (+) values are assigned in the northern direction thereof and (−) values are assigned in the southern direction thereof, is called the declination.

In addition, the constellation may vary according to the city where a user is located. Accordingly, information about the locations and longitudes of all of the cities in all of the countries of the world is generally stored in the database 20 additionally. As a result, in the case where a constellation is searched for in some country other than one's own country, the city where the user exists must be selected, and the constellation search means 40 calculates the constellation with reference to the latitude and longitude of the corresponding city in the database 20 according to city ID information.

Meanwhile, the constellation search means 40, unlike the above-described function, outputs the azimuth and the altitude, which are provided from the 3-dimensional module 10, through the output means 30. Furthermore, when time information for constellation searching is inputted, the constellation search means 40 reads all of the pieces of constellation location information in the database 20, searches for constellations corresponding to the input constellation time information, and outputs the search results through the output means 30. Furthermore, when ID information about any one of the found and outputted constellations, the location of which is desired to be known, is inputted, the constellation search means 40 allows corresponding information to be outputted through the output means 30.

Accordingly, the constellation search means 40, as shown in FIG. 3, includes a reception unit 100 for receiving azimuth and altitude values for a direction indicated by the 3-dimensional module 10, a constellation search unit 102 for searching for constellations located at the azimuth and altitude values received by the reception unit 100, based on constellation location information stored in the database 20, and an output unit 104 for outputting search results found by the constellation search unit 102 to the output means 30. According to the need, a virtual sky implementation unit 102 for reading constellation location information from the database 20, converting the read information into a horizontal coordinate system depending on the current time, implementing the stars of constellations, for which the altitude values of the horizontal coordinate system are positive (+), in a virtual sky, and transferring the results to the constellation search unit 102, may be further included in FIG. 3.

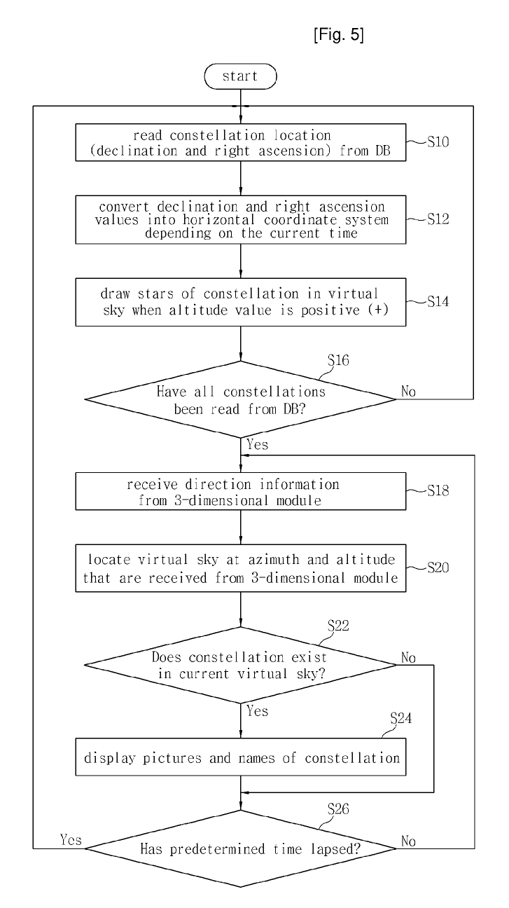

Furthermore, the constellation search means 40, as shown in FIG. 4, may include a reception unit 110 for receiving the azimuth and altitude values for a direction indicated by the 3-dimensional module 10, an output unit 112 for outputting current azimuth and altitude indicated by the 3-dimensional module 10 to the output means 30 and outputting azimuth and altitude to be indicated by the 3-dimensional module 10 to the output means 30, and a constellation search unit 114 for performing signal processing such that the azimuth and altitude values, which are received by the reception unit 110, are displayed on a screen and then transferring signal processing results to the output unit 112, and a constellation search unit 114 for calculating the azimuth and altitude values to be indicated by the 3-dimensional module 10 based on the constellation location information of the database, in response to the input of the ID information of a constellation selection signal, and then transferring the calculation results to the output unit 112.

When information about a constellation existing for a direction indicated by the 3-dimensional module 10 or information about constellation desired by the user is provided, the above-described constellation search means 40 provides the information using a horizontal coordinate system. The horizontal coordinate system is a coordinate system used to describe the location of a celestial body in the celestial sphere, and a horizontal plane is the reference plane thereof. One single coordinate of the horizontal coordinate system, is an altitude that indicates the altitude angle from the horizontal plane, and the other coordinate is the azimuth angle from the horizontal plane.

Although, in FIG. 1, the database 20, the output means 30, and the constellation search means 40 are illustrated as being separate, the database 20 and the output means 30 may be configured to be included in the constellation search means 40. Furthermore, the database 20, the output means 30, and the constellation search means 40 may constitute a single apparatus, for example, a fixed-type personal computer or a mobile terminal. In this case, the mobile terminal may be a cellular phone, a mobile phone, a PDA, a notebook, an electronic pocketbook, or a voice player, such as an MP3 player.

In particular, although not shown, the constellation search means 40 includes an input means, such as a keyboard, a mouse, or a general voice recognition software package, a timer for time counting, and a processing means, such as a Central Processing Unit (CPU) that enables operation processing.

Furthermore, the 3-dimensional module 10 and the constellation search means 40 communicate with each other through a Universal Serial Bus (USB) interface or an Institute of Electrical and Electronics Engineers (IEEE) 1394 interface.

A constellation search method according to the present invention is described below.

A method of searching the constellation information for a direction indicated by the 3-dimensional module 10 and notifying a user of the found information is described with reference to the flowchart of FIG. 5. Furthermore, the description is made on the assumption that the 3-dimensional module 10 and the constellation search means 40 are connected with each other through the USB interface or the IEEE 1394 interface, and the database 20, the output means 30, and the constellation search means 40 constitute a single apparatus, for example, a fixed-type personal computer or a notebook. Furthermore, when the 3-dimensional module 10 and the constellation search means 40 are connected to each other, the constellation search program is automatically activated in the constellation search means 40 and, therefore, the mode thereof switches to a constellation search mode, so that the program executes the following operations. On the other hand, after the 3-dimensional module 10 and the constellation search means 40 are connected to each other, activation of the constellation search program can be implemented through direct key input.

That is, the constellation search means 40 reads the constellation location information (declination and right ascension) stored in the database 20 (at step S10) and converts the read information into a horizontal coordinate system depending on the current time (at step S12).

When the altitude value of a corresponding constellation based on the conversion to the horizontal coordinate system is positive (+), the constellation search means 40 draws the stars of the corresponding constellation in a virtual sky (at step S14). In this case, the virtual sky, which is a calculated sky that exists in a program, is a sky that exists in a program to indicate the stars on a final output screen (that is, a screen in which constellations are included).

As described above, the constellation search means 40 converts the locations of all constellations, which are stored in the database 20, into the horizontal coordinate system and indicates the converted locations on the virtual sky. In this case, the constellation search means 40 reads all of the constellations stored in the database 20, and displays constellations, the altitude values of which are positive (+), on the virtual sky (“Yes” at step S16). Thereafter, the constellation search means 40 receives directional information from the 3-dimensional module 10 through the USB interface or the IEEE 1394 interface (at step S18). In this case, the 3-dimensional module 10 internally calculates the azimuth angle(θ), pitch angle (α; altitude), and roll angle(β; tilt) of the indicated direction and transfers the calculated results to the constellation search means 40.

Accordingly, the constellation search means 40 locates the virtual sky, in which the constellations are displayed, at the azimuth and the altitude received from the 3-dimensional module 10 (at step 20).

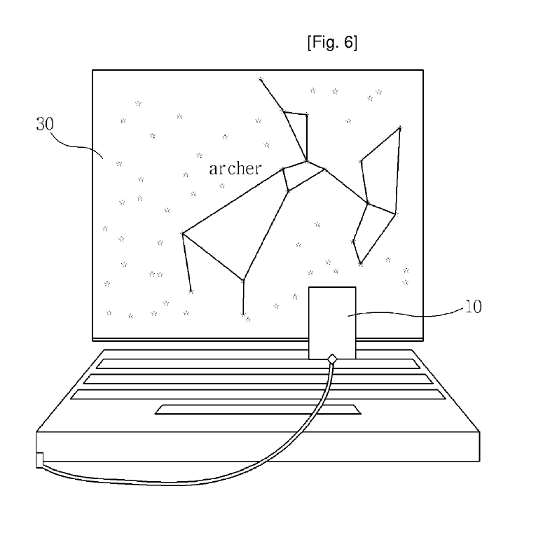

As a result, when a constellation exists in a current virtual sky (“Yes” at step 22), the constellation search means 40 displays the picture of the existing constellation on the screen of the output means 30 as in FIG. 6 and, at the same time, displays the name of the corresponding constellation on the screen (at step S24). Furthermore, the constellation search means 40 outputs the detailed information about the constellation (for example, the discoverer and related stories) through the speaker of the output means 30 in voice form while displaying the picture and name of the constellation on the screen.

When a predetermined time (for example, about 30 minutes) has not elapsed (“No” at step 26) after the output of the picture and name of the constellation at the step S24, the operation of the constellation search means 40 returns to step S18 and repeats from that step. In contrast, when a predetermined time has lapsed (“Yes” at step 26), the operation of the constellation search means 40 returns to step S10 and repeats from that step.

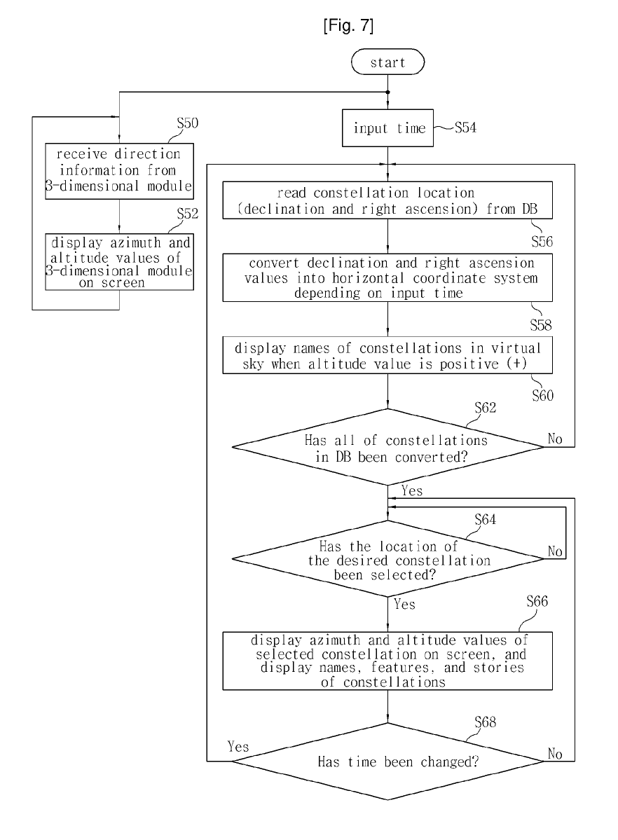

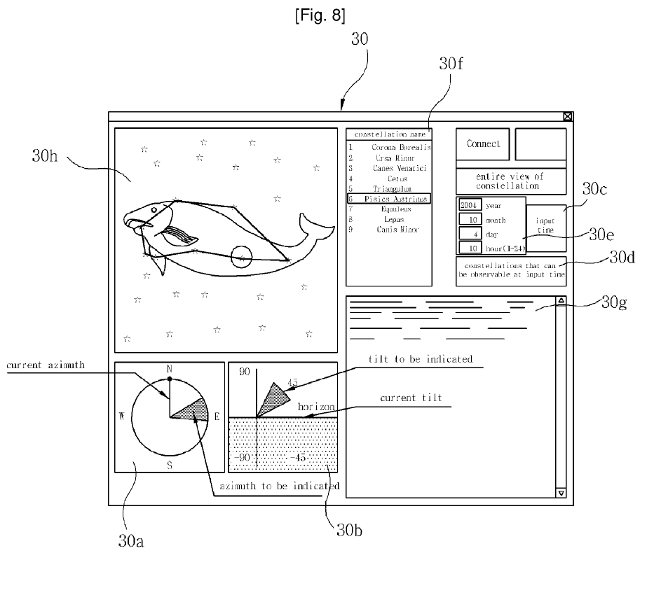

A search method for the case where a constellation that a user desires to find is directly inputted is described with reference to the flowchart of FIG. 7 below. The description is made on the assumption that the 3-dimensional module 10 and the constellation search means 40 are connected with each other through the USB interface or the IEEE 1394 interface, and the database 20, the output means 30, and the constellation search means 40 constitute a single apparatus, that is, as an example, a fixed-type personal computer or a notebook. Furthermore, the following operation may be performed in such a way that the 3-dimensional module 10 and the constellation search means 40 are connected to each other, the constellation search program is automatically activated in the constellation search means 40 and, therefore, the mode thereof switches to constellation search mode. In the case where switching to constellation search mode is automatically performed, it is assumed that an initial screen, which is divided into a plurality of display areas, is displayed on the output means 30 as in FIG. 8.

That is, when the constellation search means 40 receives direction information (azimuth and altitude) from the 3-dimensional module 10 that indicates an arbitrary direction, the current azimuth and altitude (tilt) values of the 3-dimensional module 10 are displayed on the screen of the output means 30 (at steps S50 and S52). In this case, only the current azimuth is displayed in an azimuth display area 30a in FIG. 8, and only the current tilt is displayed in a tilt display area 30b in FIG. 8.

Thereafter, the user directly inputs the time (that is, year/month/day/hour) for which constellation information is desired to be known, to the initial screen of FIG. 8, or selects the current time from the initial screen (at step S54). In other words, the user may input a desired time through the time input areas 30c and 30d, or selects the current time through the current time selection area 30e.

When the user inputs a predetermined time through the time input areas 30c and 30d or the current time selection area 30e, the constellation search means 40 reads constellation location information (declination and right ascension) stored in the database 20 (at step S56) and converts the read information into the horizontal coordinate system depending on the time (at step S58).

Thereafter, when the altitude value of a corresponding constellation based on the conversion to the horizontal coordinate system is positive (+), the constellation search means 40 displays the stars of the corresponding constellation in a name display area 30f (at step S60).

As described above, the constellation search means 40 converts the locations of all of the constellations stored in the database 20 into the horizontal coordinate system and displays the name of the constellations. In this case, the constellation search means 40 reads all of the constellations stored in the database 20, and displays the names of constellations, the altitude values of which are positive (+) (“Yes” at step S62). Thereafter, the constellation search means 40 determines which is selected from among a plurality of constellation names displayed in the constellation name display area 30f (at step S64).

When a certain constellation name is selected and ID information corresponding to the selected name is inputted (“Yes” at step S64), the constellation search means 40 displays the azimuth and altitude values of the selected constellation on the screen of the output means 30 and simultaneously displays the name, features, and stories related to the selected constellation on the screen (at step S66). For example, in FIG. 6, an azimuth to be indicated is additionally displayed in the azimuth display area 30a, a tilt to be indicated is displayed on the tilt display area 30b, the name, features, and related stories of the selected constellation are displayed in the description display area 30g in text form, and the shape of the selected constellation is displayed in the constellation shape display area 30h.

Thereafter, when the user changes the time (“Yes” at step S68), the constellation search means 40 provides constellation information corresponding to the changed time like the above-described operation.

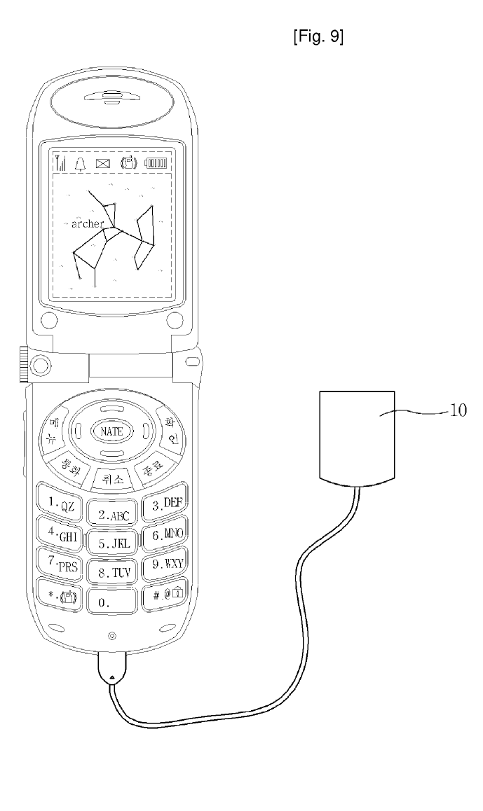

Meanwhile, FIG. 9 is a view of the apparatus of the present invention implemented in a mobile phone, and the database 20, the output means 30 and the constellation search means of FIG. 1 are installed in the mobile phone without change. Although, in FIG. 9, the mobile phone is illustrated as an example, the apparatus of the present invention may be implemented in a cellular phone, a PDA, or an electronic pocketbook. Furthermore, the mobile phone of FIG. 9 performs the operation of the FIG. 5 or 7.

Meanwhile, in FIG. 9, the mobile phone and the 3-dimensional module 10 are configured so as to communicate with each other through a USB interface or an IEEE 1394 interface. Furthermore, the 3-dimensional module 10 may be mounted in a mobile terminal, such as a mobile phone.

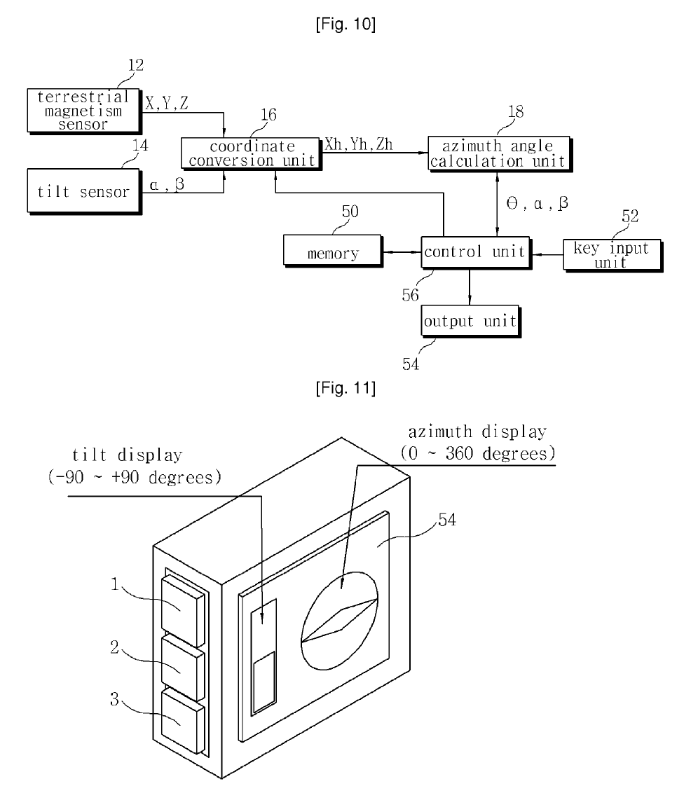

When the 3-dimensional module 10 is mounted in the mobile terminal, such as a mobile phone, as shown in FIG. 10, the mobile terminal includes a terrestrial magnetism sensor 12 for detecting the flow of an earth magnetic field generated by the earth, and outputting magnetism vectors X, Y, and Z; a tilt sensor 14 for detecting the tilt, pitch, and roll of a corresponding 3-dimensional module, and outputting a pitch angle α and a roll angle β; a coordinate conversion unit 16 for receiving magnetism vectors X, Y, and Z from the terrestrial magnetism sensor 12, receiving the pitch angle α and the roll angle β from the tilt sensor 14, and performing coordinate conversion, thus calculating horizontal magnetism vectors Xh, Yh, and Zh; an azimuth angle calculating unit 18 for calculating an azimuth angle θ based on the X-axis component Xh and the Y-axis component Yh of the horizontal magnetism vectors Xh, Yh, and Zh provided from the coordinate conversion unit 16, and outputting the calculated θ, pitch angle (α; altitude) and roll angle (β; tilt); memory 50 for previously storing a plurality of pieces of constellation information (for example, constellation names, constellation locations (declination and right ascension), features, and related stories) in a look-up table form; a key input unit 52 having a switch for turning on/off an operation and buttons for inputting other operation command signals; an output unit 54 provided with a screen display unit, such as a video monitor or a small-sized liquid crystal display panel, and/or a voice output unit, such as a speaker; and a control unit 56 for storing a program that enables constellation searching, reading all the constellation information from the memory 50 and displaying the read information on the virtual sky, locating the virtual sky at the azimuth and altitude received from the azimuth angle calculation unit 18, determining whether constellations exist in the virtual sky, and outputting the results through the output unit 54.

Although not described in more detail, the control unit 56 has other functions described in conjunction with the constellation search means 40 of FIG. 1.

In particular, the mobile terminal of FIG. 10 has a download function, so that the constellation search program and the plurality of pieces of constellation information to be stored in the memory 50 may be downloaded from an Internet site. The information stored in the memory 50 may be updated. In the mobile terminal, when the user manipulates the key input unit 52 and enters into a constellation search mode, the above-described operation of FIG. 5 or FIG. 7 can be performed.

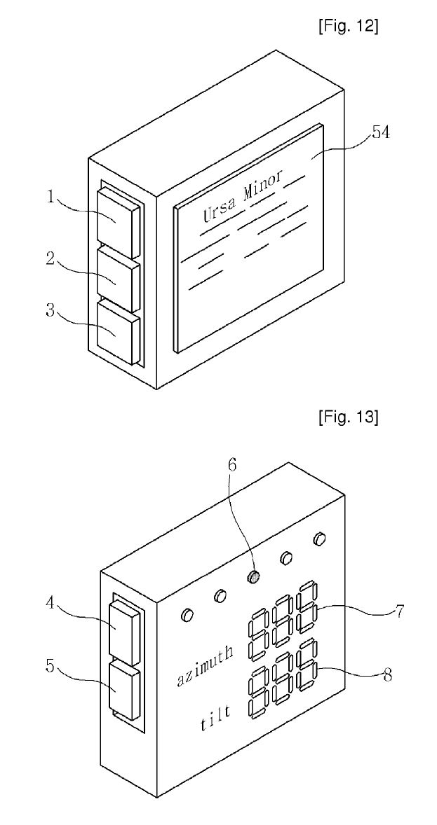

FIGS. 11 and 12 are views of the apparatus of the present invention implemented in the 3-dimensional module of FIG. 1. In this case, the 3-dimensional module may also be a mobile terminal so that the components of the apparatuses shown in FIGS. 11 and 12 are the same as those of FIG. 10.

In FIGS. 11 and 12, reference numeral 54 designates an output unit, such as a liquid crystal display panel. The output unit 54 is installed on a side of the apparatus of FIG. 11 or FIG. 12, and displays a current tilt in a range from −90 to +90 degrees and, at the same time, displays a current azimuth in a range from 0 to 360 degrees (FIG. 11).

Furthermore, the output unit 54 displays descriptions of constellations in text form (FIG. 12). In FIGS. 11 and 12, reference numerals 1 and 3 designate buttons for moving a cursor upward and downward and scrolling text, and reference numeral 2 designates button for starting, terminating the operation of the constellation search mode, and selecting a desired one from among the menus displayed on the output unit 54 in the constellation search mode. The buttons 1, 2 and 3 constitute a key input unit 52.

In accordance with the apparatuses of FIG. 11 and FIG. 12, when the user turns on the corresponding apparatus by pressing the button 2 and then orients the apparatus, the tilt and azimuth of a corresponding direction are displayed on the output unit 54 through internal signal processing and then descriptions of constellations existing in the corresponding direction are displayed in text form.

Meanwhile, when the user causes the plurality of constellation names stored in the memory 50 to be displayed on the output unit 54 in the apparatuses of FIGS. 11 and 12 and then selects a constellation, the tilt and azimuth of the corresponding constellation may also be displayed on the output unit 54.

FIG. 13 is a modified example of FIGS. 11 and 12, and shows an apparatus that is internally provided with components identical to those of FIG. 10. In FIG. 13, reference numeral 5 designates a button used for selecting and changing a desired one of the plurality of pieces of constellation information stored in the memory 50, reference numeral 6 designates a plurality of indication devices (for example, light emitting diodes) for indicating whether a selected constellation is one of the constellations stored in the memory 50, reference numeral 7 designates seven-segment elements for indicating a current azimuth in a range from 0 to 360 degrees, reference numeral 8 designates seven-segment elements for indicating a current tilt in a range from −90 to +90 degrees, and reference numeral 4 designates a button for moving indication devices 6 at the time of a mode change and indicating a current azimuth and a current tilt at the time of a selection mode. Furthermore, although not shown in FIG. 13, indication devices turned on and off when the apparatus, which is oriented in the direction of a constellation desired by the user, may be separately provided.

In accordance with the apparatus of FIG. 13, when the user selects a desired constellation using the buttons 4 and 5, signal processing is internally performed in the apparatus so that the azimuth of the corresponding constellation is indicated by the seven-segment elements 7 and the tilt of the corresponding constellation is indicated by the seven-segment elements 8.

Meanwhile, when the user views the azimuth and tilt that are indicated by the seven-segment elements 7 and 8, moves the apparatus for a direction corresponding to the azimuth and the tilt and, thereby, causes the corresponding apparatus to correspond with the azimuth and tilt, the indication device, which is additionally provided, turns on and off. Therefore, the user becomes aware that the selected constellation exists in the direction in which the current apparatus (that is, the apparatus of FIG. 13) is oriented.

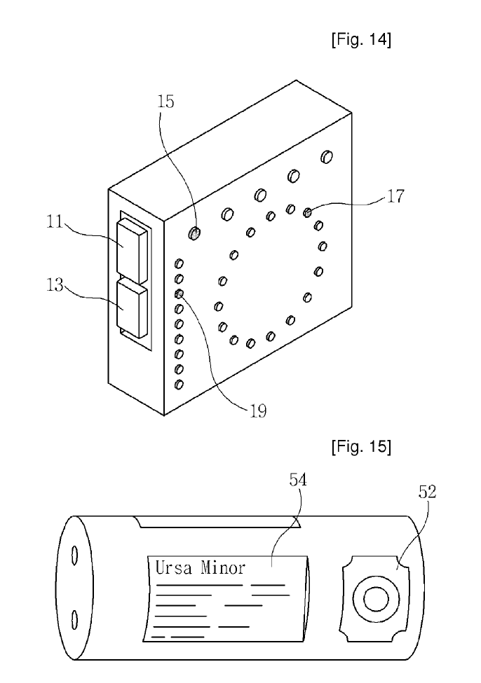

FIG. 14 is a modified example of FIG. 11 and FIG. 12, and shows an apparatus that is internally provided with the same components as those of FIG. 10 and is provided with components almost identical to those of FIG. 13. In FIG. 14, a button 11 performs the same function as the button 4 of FIG. 13, a button 13 performs the same function as the button 5 of FIG. 13, indication devices 15 perform the same function as those of FIG. 13, indication devices 17 perform the same function as the seven-segment elements 7 of FIG. 13, and indication devices 19 perform the same function as the seven-segment element 8 of FIG. 13. Furthermore, although not shown in FIG. 14, indication devices that turn on and off when a corresponding apparatus is oriented in the direction of a constellation desired by the user may be separately provided.

Accordingly, in accordance with the apparatus of FIG. 14, when a user selects a desired constellation using buttons 11 and 13, signal processing is performed in the apparatus so that the azimuth of the corresponding constellation is indicated by the indication devices 17 and the tilt of the corresponding constellation is indicated by the indication devices 19.

Meanwhile, when the user moves the corresponding apparatus in the direction corresponding to the azimuth and the tilt while viewing the azimuth and tilt which are indicated by the indication devices 17 and 19 and, thereby, causes the corresponding apparatus to correspond with the azimuth and tilt, the indication device, additionally provided, turns on and off. Therefore, the user becomes aware that the selected constellation exists in the direction in which the current apparatus (that is, the apparatus of FIG. 14) is oriented.

FIG. 15 is a diagram showing the apparatus of the present invention as it is implemented in a MP3 player. The apparatus of FIG. 15 is a voice player that can store and play back a voice, as can an MP3 player. The 3-dimensional module 10 is mounted in the voice player and the constellation information for a direction indicated by the 3-dimensional module 10 is provided in voice and/or text form. In other words, the apparatus of FIG. 15 also includes all of the components of FIG. 10.

Signal processing is performed in the apparatus, so that the azimuth of the corresponding constellation is indicated by the indication devices 17 and the tilt of the corresponding constellation is indicated by the indication devices 19.

Accordingly, in accordance with FIG. 15, when the user selects a desired constellation using the buttons of the key input unit 52, signal processing is performed in the apparatus so that the direction of the corresponding constellation (that is, an azimuth and an altitude) is made known using a voice so as to indicate the desired constellation and, at the same time, detailed information (for example, the discoverer and related stories) of the corresponding constellation is displayed through the output unit 54, such as a liquid crystal display panel. The detailed information about the corresponding constellation is provided using a voice.

Meanwhile, the present invention is not limited only to the above-described embodiments, and changes and modifications are possible within a range, which does not depart from the gist of the present invention, and it will be appreciated that the technical sprit to which the changes and the modifications are applied pertains to the accompanying claims. Although not shown in the drawings, azimuth can be known in the case where driving is performed at a constant velocity using a Global Positioning System (GPS), so that the present invention can be constructed such that the constellation information of a corresponding azimuth, along with geographical information, is displayed on the screen of a navigation system.

1. A constellation search apparatus, comprising:
a database for storing information about locations of a plurality of constellations; and
constellation search means comprising a reception unit for receiving azimuth and altitude values for a direction indicated by 3-dimensional direction measurement means, a constellation search unit for searching for constellations located at the azimuth and altitude values, which are received by the reception unit, based on the constellation location information stored in the database, and an output unit for outputting search results found by the constellation search unit.

2. The constellation search apparatus according to claim 1, wherein the constellation search means further comprises a virtual sky implementation unit for reading the constellation location information from the database, converting the read information into a horizontal coordinate system depending on the current time, implementing stars of the constellation, for which altitude values of the horizontal coordinate system are positive (+), in a virtual sky, and transferring the results to the constellation search unit.

3. A constellation search apparatus, comprising:
a database for storing information about locations of a plurality of constellations; and
a constellation search means including a reception unit for receiving azimuth and altitude values for a direction indicated by 3-dimensional direction measure means, a constellation search unit for performing signal processing such that the azimuth and altitude values, which are received by the reception unit, are displayed on a screen, and calculating azimuth and altitude values for a selected constellation, based on the constellation location information stored in the database, in response to input of Identification (ID) information of the selected constellation, and an output unit for outputting current azimuth and altitude that are provided by the constellation search unit and indicated by the 3-dimensional direction measurement means and outputting the azimuth and altitude calculated for the selected constellation.

4. The constellation search apparatus according to claim 3, wherein, when constellation search time information is inputted, the constellation search unit reads all of the constellation location information from the database, converts the read information into a horizontal coordinate system depending on the input time, and transfers a list of constellations, for which altitude values of the horizontal coordinate system are positive (+), to the output unit.

5. The constellation search apparatus according to claim 1, further comprising output means for outputting results, which are outputted from the output unit, to an outside user in image, voice, and/or text form.

6. The constellation search apparatus according to claim 3, further comprising output means for outputting results, which are outputted from the output unit, to an outside user in image, voice, and/or text form.

7. A mobile terminal, comprising;
a constellation search apparatus according to claim 1; and
output means for outputting results, which are outputted from the output unit, to an outside user in image, voice, and/or text form.

8. A mobile terminal, comprising;
a constellation search apparatus according to claim 2; and
output means for outputting results, which are outputted from the output unit, to an outside user in image, voice, and/or text form.

9. A mobile terminal, comprising;
a constellation search apparatus according to claim 3; and
output means for outputting results, which are outputted from the output unit, to an outside user in image, voice, and/or text form.

10. A mobile terminal, comprising;
a constellation search apparatus according to claim 4; and
output means for outputting results, which are outputted from the output unit, to an outside user in image, voice, and/or text form.

11. A constellation search method, comprising:
the first step of constellation search means receiving azimuth and altitude values for a direction indicated by 3-dimensional direction measurement means;
the second step of the constellation search means searching for constellations located at the received azimuth and altitude values based on constellation location information stored in a database; and
the third step of the constellation search means outputting search results.

12. The constellation search method according to claim 11, wherein the second step is performed in such a way as to read the constellation location information from the database, convert the read information into a horizontal coordinate system depending on the current time, determine whether constellations having the received azimuth and altitude values exist in a virtual sky that displays stars of constellations, for which altitude values of the horizontal coordinate system are positive (+).

13. A constellation search method, comprising:
the first step of constellation search means receiving azimuth and altitude values for a direction indicated by 3-dimensional direction measurement means;
the second step of the constellation search means performing signal processing such that received azimuth and altitude values are displayed on a screen, and calculating azimuth and altitude values for a selected constellation based on the constellation location information in the database, in response to input of ID information about the selected constellation; and
the third step of the constellation search means outputting the signal-processed current azimuth and altitude indicated by the 3-dimensional direction measurement means and outputting the azimuth and altitude calculated on the selected constellation.

14. The constellation search method according to claim 13, further comprising the steps of, when constellation search time information is inputted;
the constellation search means for reading the constellation location information from the database and converting the read information into a value of a horizontal coordinate system depending on the inputted time; and
outputting names of constellations for which the converted altitude values of the horizontal coordinate system are positive (+).

15. The constellation search method according to claim 11, wherein the outputted results at the third step are outputted in image, voice, and/or text form.

16. The constellation search method according to claim 13, wherein the outputted results at the third step are outputted in image, voice, and/or text form.

17. A computer-readable recording medium storing a constellation search program for implementing function of:
storage means having previously stored constellation location information about locations of a plurality of constellations; and
constellation search means comprising a reception unit for receiving azimuth and altitude values for a direction indicated by 3-dimensional direction measurement means, a constellation search unit for searching for constellations located at azimuth and altitude values received by the reception unit, based on the constellation location information stored in the storage means, and an output unit for outputting search results found by the constellation search unit.

18. A computer-readable recording medium storing a constellation search program for implementing function of:
storage means having previously stored constellation location information about locations of a plurality of constellations; and
constellation search means including a reception unit for receiving azimuth and altitude values for a direction indicated by 3-dimensional direction measurement means, a constellation search unit for performing signal processing such that the azimuth and altitude values, which are received by the reception unit, are displayed on a screen, and calculating azimuth and altitude values for a selected constellation, based on the constellation location information in the storage means, in response to input of ID information for the selected constellation, and an output unit for outputting current azimuth and altitude values that are provided by the constellation search unit and indicated by the 3-dimensional direction measurement means and outputting the azimuth and altitude values calculated for the selected constellation.

19. A constellation search program for implementing function of;
storage means having previously stored constellation location information about locations of a plurality of constellations; and
constellation search means comprising a reception unit for receiving azimuth and altitude values for a direction indicated by 3-dimensional direction measurement means, a constellation search unit for searching for constellations located at azimuth and altitude values received by the reception unit, based on the constellation location information stored in the storage means, and an output unit for outputting search results found by the constellation search unit.

20. A constellation search program for implementing function of:
storage means having previously stored constellation location information about locations of a plurality of constellations; and
constellation search means including a reception unit for receiving azimuth and altitude values for a direction indicated by 3-dimensional direction measurement means, a constellation search unit for performing signal processing such that the azimuth and altitude values, which are received by the reception unit, are displayed on a screen, and calculating azimuth and altitude values of a selected constellation, based on the constellation location information of the storage means, in response to input of ID information for the selected constellation, and an output unit for outputting current azimuth and altitude that are provided by the constellation search unit and indicated by the 3-dimensional direction measurement means and outputting the azimuth and altitude values calculated for the selected constellation.
